(19) United States
(12) Patent Application Publication
(10) Pub. No.: US 2017/0245195 A1
(43) Pub. Date: Aug. 24, 2017

(54) METHOD FOR CONTROLLING NETWORK INTERFACES OF ELECTRONIC DEVICE AND ASSOCIATED PROCESSING CIRCUIT

(71) Applicant: MEDIATEK INC., Hsin-Chu (TW)

(72) Inventors: Chi-Hsuan Lin, New Taipei City (TW); Po-Yu Chen, Hsinchu County (TW); Chih-Hsiang Hsiao, Taipei City (TW); Pei-Lun Suei, Taichung City (TW)

(21) Appl. No.: 15/050,407

(22) Filed: Feb. 22, 2016

(51) Int. Cl. H04W 40/10; H04W 52/02; H04L 12/755; H04L 12/931; H04L 12/733; H04L 12/721

(52) U.S. Cl. CPC H04W 40/10; H04L 45/126; H04L 45/124; H04L 45/021; H04L 49/405; H04W 52/0203; H04W 52/0219

(57) ABSTRACT

A method for controlling a plurality of network interfaces of an electronic device includes: providing at least one table comprising information associated with a plurality of routing costs, wherein the routing costs correspond to at least paths between each of the network interfaces of the electronic device and the other electronic devices; and referring to the at least one table to select a specific network interface to transmit/receive data, and to disable at least one of the unused network interfaces.

### BACKGROUND

Recently, an electronic device generally has many different network interfaces (heterogeneously network) for transmitting data or control signals. Because the data transmission has large power consumption, a network interface control mechanism is applied to some energy constrained devices to save power. However, the conventional network interface control mechanism only considers the battery state or the transmission powers of the network interfaces, so the power management may not be optimized due to the loss of some important factors.

### SUMMARY

It is therefore an objective of the present invention to provide a method for controlling a plurality of network interfaces of the electronic device, which can control the network interfaces by considering more factors such as standby power, switch overhead and/or data size, to solve the above-mentioned problems.

According to one embodiment of the present invention, a processing circuit of an electronic device is provided, wherein the electronic device comprises a plurality of network interfaces for wirelessly communicating with other electronic devices and a storage unit for storing at least one table comprising information associated with a plurality of routing costs, and the routing costs correspond to at least paths between each of the network interfaces of the electronic device and the other electronic devices. The processing circuit is arranged for referring to the at least one table to select a specific network interface to transmit/receive data, and to disable at least one of the unused network interfaces.

According to another embodiment of the present invention, a method for controlling a plurality of network interfaces of an electronic device, comprising: providing at least one table comprising information associated with a plurality of routing costs, wherein the routing costs correspond to at least paths between each of the network interfaces of the electronic device and the other electronic devices; and referring to the at least one table to select a specific network interface to transmit/receive data, and to disable at least one of the unused network interfaces.

According to another embodiment of the present invention, a method for controlling a plurality of network interfaces of an electronic device, wherein the plurality of network interfaces comprises a first network interface and a second network interface, and the method comprises: using the first network interface to transmit data or receive data from another device; after the data is completely transmitted/received, comparing standby powers of the first network interface and the second network interface; and when the standby power of the first network interface is greater than the standby power of the second network interface, disabling the first network interface, and using the second network interface for standby.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a communication system according to one embodiment of the present invention.

FIG. 2 is a diagram illustrating the total energy consumption of the Wi-Fi, BT, and “Wi-Fi with switch overhead” with different data size (file size) for data transmission.

FIG. 3 is a diagram illustrating the routing table and the routing costs when the data size for data transmission is less than a reference value according to one embodiment of the present invention.

FIG. 4 is a diagram illustrating the routing table and the routing costs when the data size for data transmission is greater than a reference value according to one embodiment of the present invention.

FIG. 5 is a diagram illustrating the routing table and the routing costs according to another embodiment of the present invention.

FIG. 6 is a diagram showing that the routing table shown in FIG. 5 is updated due to the lower battery issue according to one embodiment of the present invention.

FIG. 7 is a diagram illustrating a communication system according to another embodiment of the present invention.

FIG. 8 is a diagram illustrating a communication system according to another embodiment of the present invention.

FIG. 9A and FIG. 9B are diagrams illustrating a network interface switch according to one embodiment of the present invention.

FIG. 10 shows a flowchart of a method for controlling a plurality of network interfaces of an electronic device according to one embodiment of the present invention.

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” The terms “couple” and “couples” are intended to mean either an indirect or a direct electrical connection. Thus, if a first device couples to a second device, that connection may be through a direct electrical connection, or through an indirect electrical connection via other devices and connections.

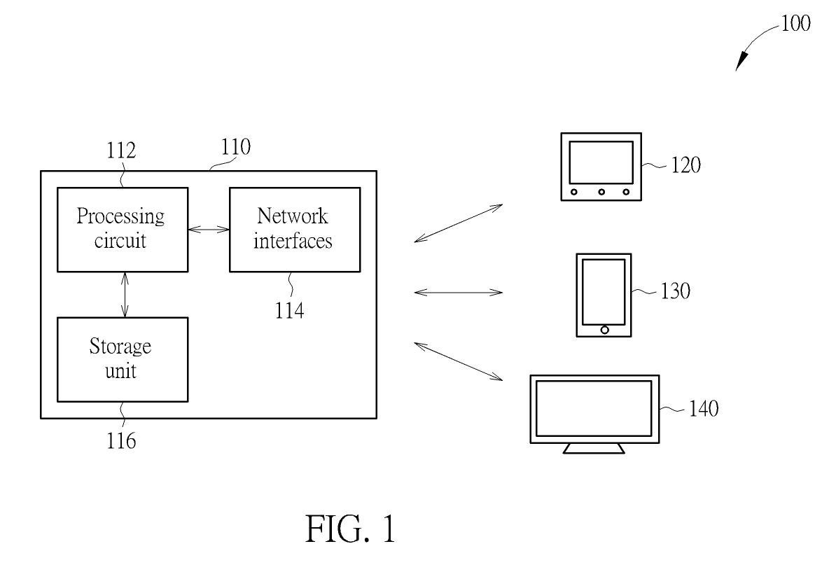

Please refer to FIG. 1, which is a diagram illustrating a communication system 100 according to one embodiment of the present invention. As shown in FIG. 1, the communication system 100 comprises a plurality of electronic device (in this embodiment, there are four electronic devices 110, 120, 130 and 140). Taking the electronic device 110 as an example, the electronic device 110 comprises a processing circuit 112, a plurality of network interfaces 114 and a storage unit 116. In this embodiment, each of the electronic devices 110, 120, 130 and 140 may be a smart phone, a tablet, a smart watch, a notebook, a smart TV, or any other electronic device capable having wireless network interface. In addition, the network interfaces 114 may comprise at least two of Ethernet, Wi-Fi, Bluetooth (BT), Bluetooth low energy (BLE), Zigbee, Long Term Evolution (LTE), IEEE 8012.15.4, ANT+, and any other network interfaces; and the processing circuit 112 may comprise one or more integrated circuits for controlling the operations of the network interfaces 114.

In the embodiment of the present invention, the storage unit 116 stores at least one routing table and a plurality of routing costs, and the routing costs correspond to paths between each of the network interfaces of the electronic device 110 and the other electronic devices 120, 130 and 140, and further correspond to paths between the other electronic devices 120, 130 and 140. In this embodiment, the routing costs are indexes for the power consumption, and the larger the routing cost, the larger the power consumption. When the electronic device 110 is required to transmit data to the other electronic device, the processing circuit 112 may refer to the routing costs and/or the routing table to select a specific network interface and a preferred route to transmit/receive data, and to disable at least one of the unused network interfaces.

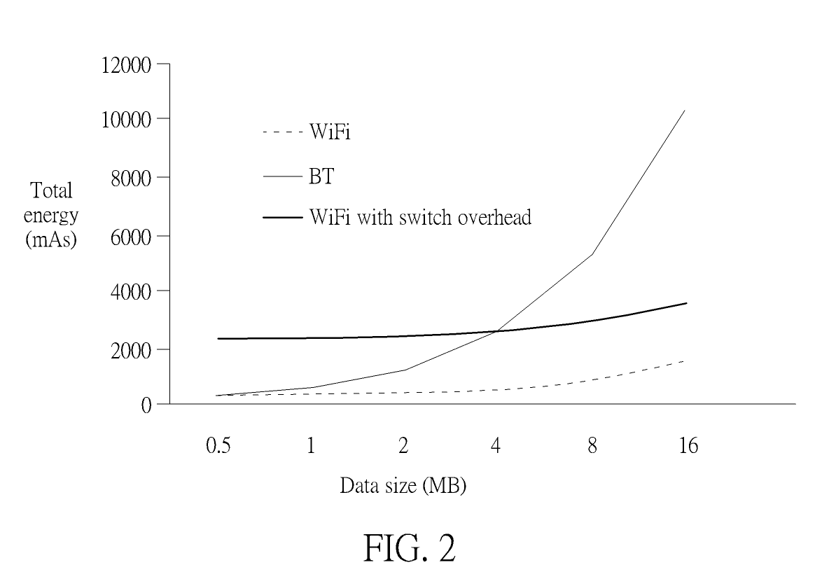

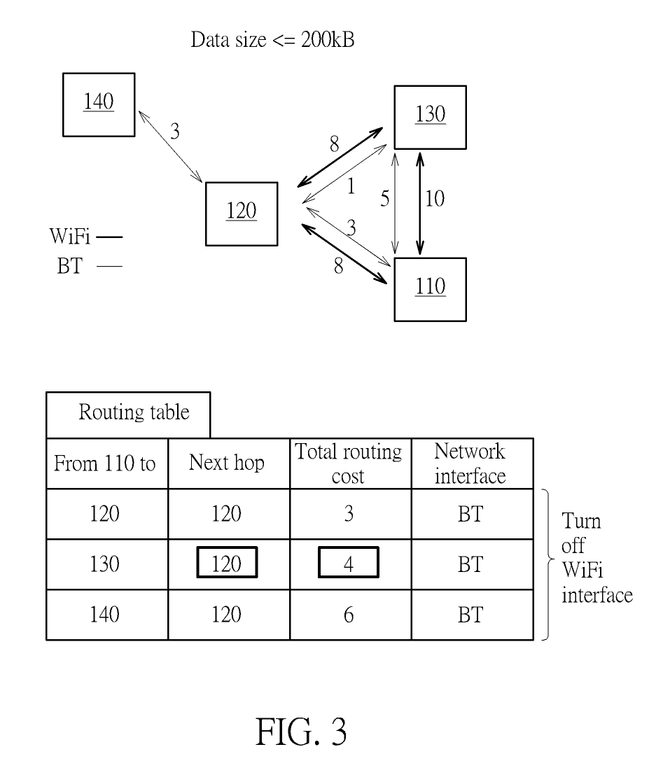

In detail, refer to FIG. 2, which is a diagram illustrating the total energy consumption of the Wi-Fi, BT, and “Wi-Fi with switch overhead” with different data size (file size) for data transmission, wherein the “Wi-Fi with switch overhead” further comprises additional power consumption when the Wi-Fi turns on or turns off. As shown in FIG. 2, because the curves for the Wi-Fi (with switch overhead) and BT have a cross point, so the routing costs corresponding to paths between the network interfaces of the electronic device 110 and the other electronic devices 120, 130 and 140 have different values for different data sizes. Please refer to FIG. 3, which is a diagram illustrating the routing table and the routing costs when the data size for data transmission is less than a reference value (e.g. 200 kB, without limitation) according to one embodiment of the present invention. For simplicity, FIG. 3 merely uses the Wi-Fi (with switch overhead) and BT as the network interfaces, but it's not a limitation of the present invention. As shown in FIG. 3, the routing costs between the electronic devices 110-140 are calculated or obtained, and the processing circuit 112 uses the routing costs shown in FIG. 3 to build the routing table to determine the optimization route for data transmission. For example, FIG. 3 also shows the routing table regarding the data transmission from the electronic device 110 to the other electronic device 120, 130 and 140. Regarding the data transmission from the electronic device 110 to the electronic device 120, because using the BT has the lowest total routing cost “3”, so the routing table records that the electronic device 110 may use the BT to directly transmit data to the electronic device 120. Regarding the data transmission from the electronic device 110 to the electronic device 130, because using the electronic device 120 serving as the intermediary with the BT has the lowest total routing cost “4”, so the routing table records that the electronic device 110 may use the BT to indirectly transmit data to the electronic device 130 via the electronic device 120, instead of using Wi-Fi or BT to directly transmit the data to the electronic device 130 (direct transmission has large cost). Regarding the data transmission from the electronic device 110 to the electronic device 140, because using the electronic device 120 serving as the intermediary with the BT has the lowest total routing cost “6”, so the routing table records that the electronic device 110 may use the BT to indirectly transmit data to the electronic device 140 via the electronic device 120.

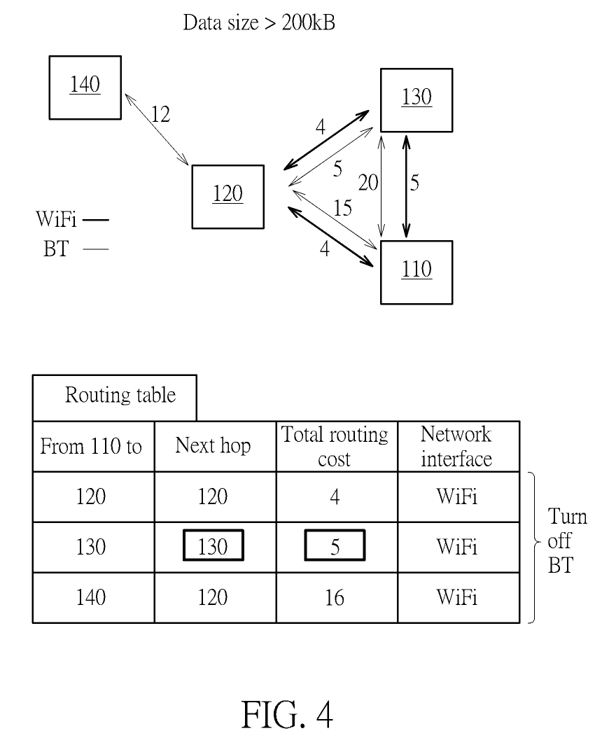

Please refer to FIG. 4, which is a diagram illustrating the routing table and the routing costs when the data size for data transmission is greater than the reference value (e.g. 200 kB, without limitation) according to one embodiment of the present invention. As shown in FIG. 4, the routing costs between the electronic devices 110-140 are calculated or obtained, and the processing circuit 112 uses the routing costs shown in FIG. 3 to build the routing table to determine the optimization route for data transmission. For example, FIG. 4 also shows the routing table regarding the data transmission from the electronic device 110 to the other electronic device 120, 130 and 140. Regarding the data transmission from the electronic device 110 to the electronic device 120, because using the Wi-Fi has the lowest total routing cost “4”, so the routing table records that the electronic device 110 may use the Wi-Fi to directly transmit data to the electronic device 120. Regarding the data transmission from the electronic device 110 to the electronic device 130, because using the Wi-Fi has the lowest total routing cost “5”, so the routing table records that the electronic device 110 may use the Wi-Fi to directly transmit data to the electronic device 130. Regarding the data transmission from the electronic device 110 to the electronic device 140, because using the electronic device 120 serving as the intermediary with the Wi-Fi has the lowest total routing cost “16”, so the routing table records that the electronic device 110 may use the Wi-Fi to indirectly transmit data to the electronic device 140 via the electronic device 120.

In addition, the routing costs can be calculated by considering at least a portion of the battery states of the electronic devices 110-140, the transmission powers of the network interfaces 114, signal to noise ratio (SNR) of the network interfaces 114, switch overheads of the network interfaces and the data size. For example, assuming that the data is transmitted from “A” to “B” with network interface “I”, the corresponding routing cost can be calculated by using the following formula:

$$Routing cost = \frac{{{P}_{TX \_ A} ( I )}^{*} data\_size + {P}_{switch \_ A} ( I )}{battery\_state \_A} + \frac{{{P}_{RX \_ B} ( I )}^{*} data\_size + {P}_{switch \_ B} ( I )}{battery\_state \_B} ,$$

wherein P_{TX}_{_}_{A}(I) is the transmission power of the network interface “I” of the electronic device “A”, P_{switch}_{_}_{A} (I) is a switch overhead of the network interface “I” of the electronic device “A”, battery_state_A is an index of a residual capacity of a battery of the electronic device “A”, P_{RX}_{_}_{B}(I) is the reception power of the network interface “I” of the electronic device “B”, P_{switch}_{_}_{B}(I) is a switch overhead of the network interface “I” of the electronic device “B”, battery_state_B is an index of a residual capacity of a battery of the electronic device “B”.

In addition, in this embodiment, the routing costs can be directly obtained from the other electronic devices. For example, the electronic device 120 can calculate the routing cost between the electronic devices 120 and 140, and sends this routing cost to the electronic device 110 for building the routing table.

In the above-mentioned embodiment, each routing cost is symmetric, that is the routing cost corresponding to the transmission from “A” to “B” and the routing cost corresponding to the transmission from “B” to “A” are the same. In other embodiments of the present invention, one or more routing costs may be asymmetric, for example, the routing cost corresponding to the transmission from “A” to “B” may be “9”, while the routing cost corresponding to the transmission from “B” to “A” may be “10”.

In light of above, when the electronic device 110 wants to transmit data to one of the other electronic devices 120-140, the processing circuit 112 may refer to the routing table to find the optimal route (with lowest total power consumption) and an optimal network interface, and uses the selected optimal network interface to transmit data. Meanwhile, the processing circuit 112 also disables the other unused (redundant) network interface (s) to save the standby power consumption of these unused (redundant) network interface(s). For example, if the processing circuit 112 uses the BT to transmit data to the electronic device 120, the Wi-Fi interface can be turned off to disconnect the Wi-Fi link between the electronic devices 110 and 120.

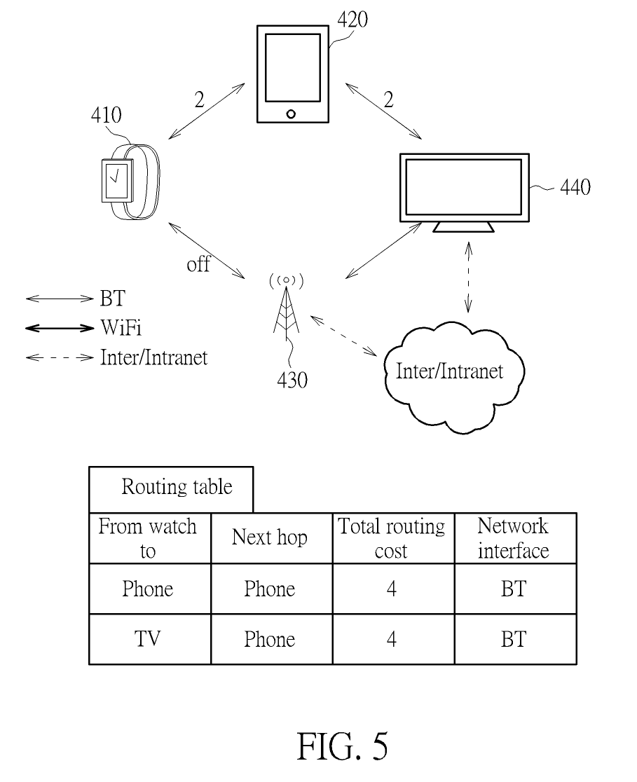

In addition, the routing costs may be updated according to a condition of the electronic device, and the updated routing costs are transmitted to the other electronic devices, wherein the condition may be a battery state, a signal strength and/or other indexes of the electronic device that may change the routing costs. After the routing costs are updated, the electronic device may change the network interface and the route for power saving. For example, please refer to FIG. 5, assuming that the communication system comprises a watch 410, a phone 420, an access point (AP) 430 and a TV 440, and the watch 410 refers to the routing table stored therein to determine the optimal route and network interface to transmit data to the phone 420 and TV 440. In this embodiment, because the BT has the lowest routing costs, so the watch 410 enables the BT and uses the BT to transmit data to the phone 420 and/or TV 440, and the watch 410 further disables the Wi-Fi interface to save power.

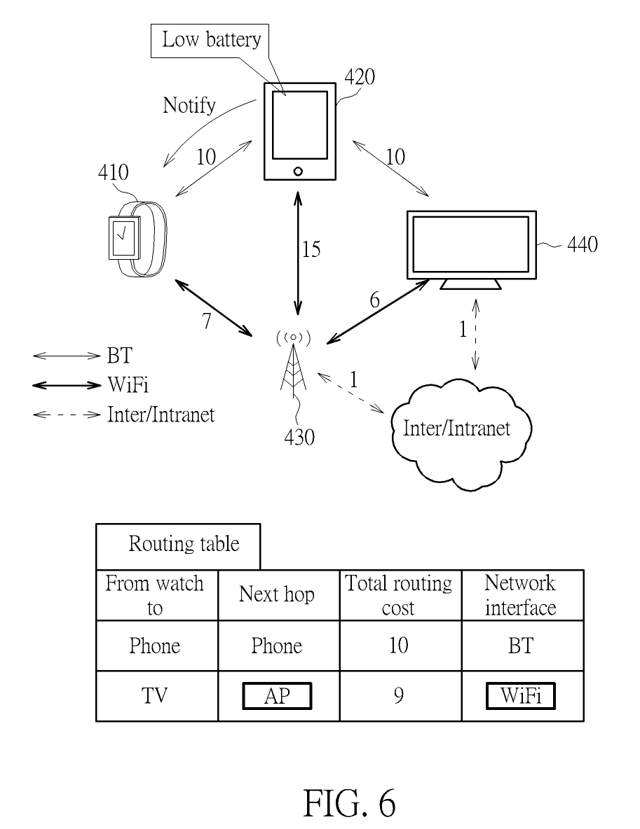

In FIG. 6, when the phone 420 suffers a low battery issue, the phone 420 may greatly increases the associated routing costs (e.g. routing costs 10, 10 and 15 shown in FIG. 6), and notifies the watch 410 that the routing costs regarding the phone 420 are updated. At this time, the watch 410 also updates the routing costs stored therein, and re-determines the optimal route and the network interface. In this embodiment, because the routing costs related to the low battery phone 420 are large, so the phone 420 is inappropriate to serve as the intermediary between the watch 410 and the TV 440. Therefore, when the watch 410 wants the transmit data to the TV 440, the watch 410 will enable the Wi-Fi interface to transmit data to the AP 430, and the AP 430 sends the received data to the TV 440 via the Internet/Intranet. Meanwhile, the watch 410 disables the BT interface to save power if the BT interface is unused.

In addition, when the data size or the battery state changes frequently, the routing table may be updated frequently to increase too much update overhead. Therefore, to solve this problem, multiple routing tables may be built and maintained for different specific ranges of data size, or multiple routing tables may be built and maintained for different network interfaces with several battery states or several data size ranges, or the electronic device may transmit the updated routing cost to the other electronic devices only when the amount of change or the value of the updated routing cost reaches a threshold. For example, assuming that the original routing cost is “10”, the electronic device may send the updated routing cost to the other electronic device only when the updated routing cost is less than “5” or greater than “15”. Costs stored in routing table can also be represented as a function of data size, which can be calculated before transmission to avoid update overhead.

In the above-mentioned embodiments, the routing costs and the routing table are provided to determine of the route and the network interface for data transmission. In another embodiment of the present invention, standby costs are further provided for the determination of the network interface in a standby mode. In one embodiment, the standby costs can be calculated by considering at least a portion of the battery states of the electronic devices, the transmission powers of the network interfaces, SNR of the network interfaces, network interface types and data type.

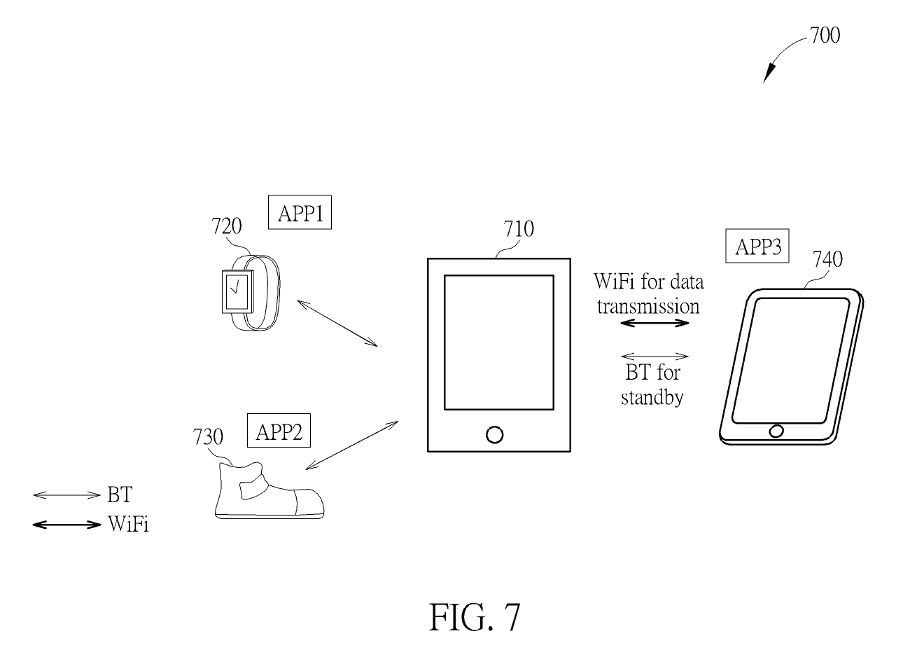

Please refer to FIG. 7, which is a diagram illustrating a communication system 700 according to another embodiment of the present invention. As shown in FIG. 7, the electronic device 710 performs three applications (APPs) with the other electronic devices 720, 730 and 740, respectively. Some APPs may use the designated network interface to transmit/receive data, in this embodiment, the electronic device 710 uses the BT interface to communicate with the electronic devices 720 and 730, and the electronic device 710 uses the Wi-Fi interface to transmit data to the electronic device 740. After the electronic device 710 finishes the data transmission, the electronic device 710 may compare the standby costs of the network interfaces for the connections between the electronic devices 710 and 740, to further determine one of the network interfaces for standby. In the embodiment shown in FIG. 7, because the Wi-Fi standby cost is greater than a summation of the BT standby cost and switching cost, the BT interface is selected for standby, that is the electronic device 710 disables the Wi-Fi interface and enables the BT interface for standby, and the BT interface is used to maintain the link between the electronic device 710 and 740.

In the embodiment shown in FIG. 7, because the electronic device 710 uses the BT interface to maintain the link with the electronic device 740, and the Wi-Fi interface of the electronic device 710 is disabled, the interference between different network interfaces (e.g. Wi-Fi and BT) can be reduced, and the communication quality can be improved.

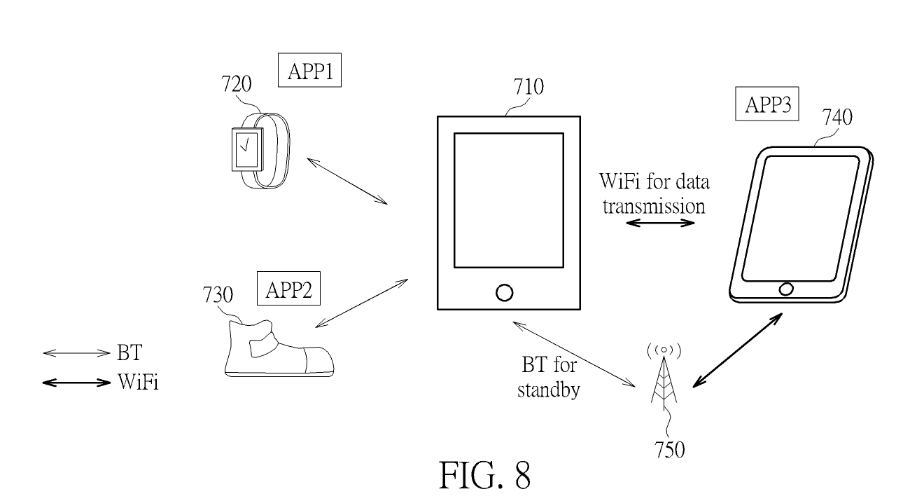

In another embodiment, referring to FIG. 8, after the electronic device 710 finishes the data transmission, the electronic device 710 may uses BT interface to main the link with the electronic device 740 via an intermediary 750, while the electronic device 740 uses the Wi-Fi interface.

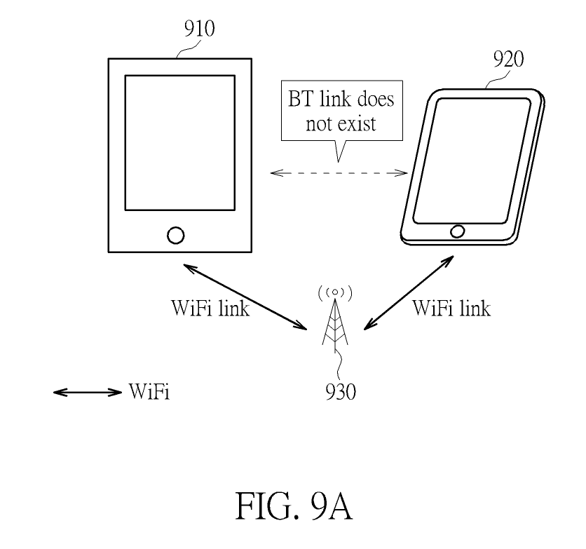

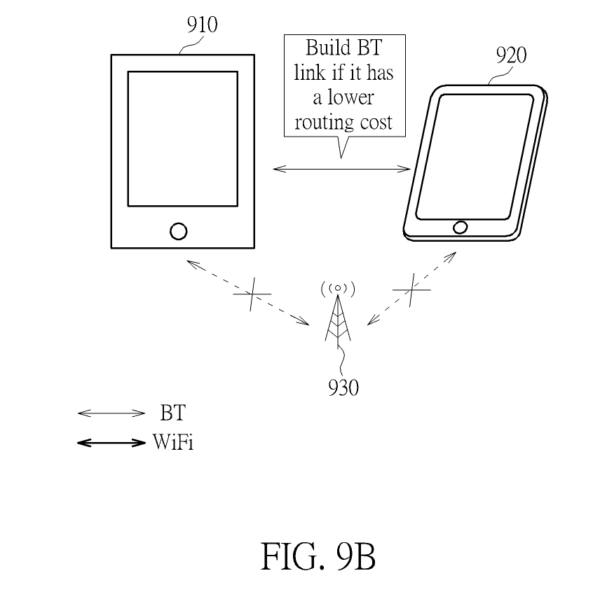

Please refer to FIG. 9A and FIG. 9B, which are diagrams illustrating a network interface switch according to one embodiment of the present invention. In FIG. 9A, the electronic device 910 communicates with the electronic device 920 via an intermediary 930 by using Wi-Fi; and at this time, the BT link does not exist between the electronic devices 910 and 920 due to the large distance. In FIG. 9B, when the electronic device 910 moves closer to the electronic device 920, the electronic device 910 may refer to the routing table or compares the routing costs of the Wi-Fi interface and BT interface to determine whether to switch the network interface. If the electronic device 910 determines that the BT link is more power efficiency than the Wi-Fi link, the electronic device 910 builds a BT link with the electronic device 920, and disables the Wi-Fi interface to save power.

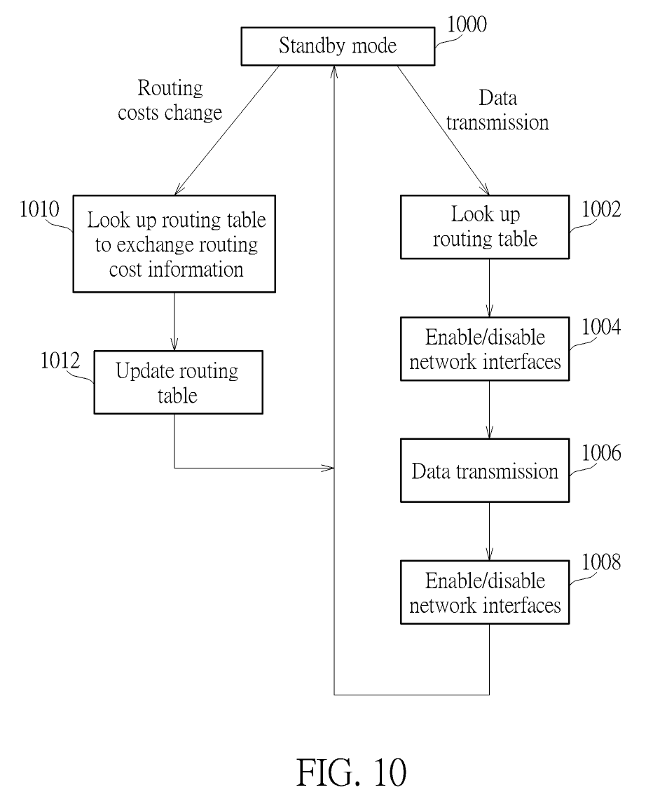

FIG. 10 shows a flowchart of a method for controlling a plurality of network interfaces of an electronic device according to one embodiment of the present invention. As shown in FIG. 10, the flow is described as follows.

Step 1000: the electronic device is in a standby mode. When the electronic device needs to transmit data, the flow enters Step 1002; and when routing costs of the electronic device change, the flow enters Step 1010.

Step 1002: the electronic device looks up the routing table to select the appropriate network interface for data transmission.

Step 1004: the electronic device enables the selected network interface and disable the unused network interface to save power.

Step 1006: the electronic device uses the selected network interface to transmit data.

Step 1008: after the data transmission, the electronic device refers to the standby costs to enable one of the network interfaces for standby, and disables the unused network interface.

Step 1010: the electronic device exchanges routing cost information with the other electronic device.

Step 1012: the electronic device updates the routing table.

Briefly summarized, in the method for controlling a plurality of network interfaces of the electronic device of the present invention, the routing costs and the standby costs are obtained by considering more factors such as standby power, switch overhead and/or data size, thereby the power management can be performed more efficient. In addition, by disabling the unused network interface and switching to another network interface for standby, the electronic device may save more power.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A processing circuit of an electronic device, wherein the electronic device comprises a plurality of network interfaces for wirelessly communicating with other electronic devices and a storage unit for storing at least a table comprising information associated with a plurality of routing costs, and the routing costs correspond to at least paths between each of the network interfaces of the electronic device and the other electronic devices; and the processing circuit is arranged for referring to the at least one table to select a specific network interface to transmit data, and to disable at least one of the unused network interfaces.

2. The processing circuit of claim 1, wherein the processing circuit calculates a portion of the routing costs based on at least switch overheads of the network interfaces.

3. The processing circuit of claim 1, wherein the processing circuit calculates a portion of the routing costs based on stand-by powers of the network interfaces.

4. The processing circuit of claim 1, wherein the processing circuit calculates a portion of the routing costs based on at least data size of the transmission data.

5. The processing circuit of claim 1, wherein the processing circuit obtains a portion of the routing costs from the other electronic devices to build the table, wherein the portion of the routing costs correspond to paths between the other electronic devices.

6. The processing circuit of claim 1, wherein the processing circuit updates the routing costs according to a condition of the electronic device, and transmits the updated routing costs to the other electronic devices.

7. The processing circuit of claim 6, wherein the condition of the electronic device is a battery state or a signal strength of the electronic device.

8. The processing circuit of claim 6, wherein the processing circuit controls the electronic device to transmit the updated routing costs to the other electronic devices when an amount of change or a value of the updated routing costs reaches a threshold.

9. The process circuit of claim 1, wherein the processing circuit updates the routing costs according to a data size to be transmitted.

10. The processing circuit of claim 1, after the data is completely transmitted, the processing circuit compares standby powers of the specific network interface and the other network interfaces, and when the specific network interface has a relative high standby power, the processor disables the specific network interface, and uses another network interface having a relative low standby power for standby.

11. A method for controlling a plurality of network interfaces of an electronic device, comprising:
providing at least one table comprising information associated with a plurality of routing costs, wherein the routing costs correspond to at least paths between each of the network interfaces of the electronic device and the other electronic devices; and
referring to the at least one table to select a specific network interface to transmit/receive data, and to disable at least one of the unused network interfaces.

12. The method of claim 11, further comprising:
calculating a portion of the routing costs based on at least switch overheads of the network interfaces.

13. The method of claim 11, further comprising:
calculating a portion of the routing costs based on stand-by powers of the network interfaces.

14. The method of claim 11, further comprising:
calculating a portion of the routing costs based on at least data size of the transmission data.

15. The method of claim 11, further comprising:
obtaining a portion of the routing costs from the other electronic devices, wherein the portion of the routing costs correspond to paths between the other electronic devices.

16. The method of claim 11, further comprising:
updating the routing costs according to a condition of the electronic device; and
transmitting the updated routing costs to the other electronic devices.

17. The method of claim 16, wherein the condition of the electronic device is a battery state or a signal strength of the electronic device.

18. The method of claim 16, wherein the step of transmitting the updated routing costs to the other electronic devices comprises:
transmitting the updated routing costs to the other electronic devices only when an amount of change or a value of the updated routing costs reaches a threshold.

19. The method of claim 11, further comprising:
after the data is completely transmitted, comparing standby powers of the specific network interface and the other network interfaces; and
when the specific network interface has a relative high standby power, disabling the specific network interface, and using another network interface having a relative low standby power for standby.

20. A method for controlling a plurality of network interfaces of an electronic device, wherein the plurality of network interfaces comprises a first network interface and a second network interface, and the method comprises:
using the first network interface to transmit data or receive data from another device;
after the data is completely transmitted/received, comparing standby powers of the first network interface and the second network interface; and
when the standby power of the first network interface is greater than the standby power of the second network interface, disabling the first network interface, and using the second network interface for standby.

21. The method of claim 20, wherein the step of using the second network interface for standby comprises:
using the second network interface to maintain a link with the another device via an intermediary device.
